(19) United States
(12) Patent Application Publication
(10) Pub. No.: US 2009/0204775 A1
(43) Pub. Date: Aug. 13, 2009

(54) DATA COPYING METHOD

(75) Inventors: Akira Satou, Kawasaki-shi (JP); Kenichi Fujita, Kawasaki (JP); Koutarou Sasage, Kawasaki (JP); Atsushi Masaki, Kawasaki (JP); Hiroshi Shiomi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/366,689

(22) Filed: Feb. 6, 2009

(30) Foreign Application Priority Data
Feb. 12, 2008 (JP) 2008-030326

(51) Int. Cl. G06F 12/16; G06F 12/00

(52) U.S. Cl. 711/162; 711/165; 711/E12.001; 711/E12.103

(57) ABSTRACT

A method for controlling a switch apparatus connectable to a host and a storage device including first and second areas, the method includes: establishing schedule of copying data stored in the first area of the storage device into the second area of the storage device; monitoring a state of access by the host to the storage device; carrying out copying the data stored in the first area into the second area while the monitored state of the access by the host allows copying of the data from the first area into the second area; and enhancing copying, if any portion of the data remains when a time set by the schedule is expired, the remaining portion of the data from the first area into the second area.

### CROSS-REFERENCE TO RELATED APPLICATION

This application is based upon and claims the benefit of priority of the prior Japanese Patent Application No. 2008-030326, filed on Feb. 12, 2008, the entire contents of which are incorporated herein by reference.

### FIELD

The embodiment discussed herein is related to a data copying method of a network system.

### BACKGROUND

Japanese Laid-open Patent Publication Nos. 2007-94994 and 2007-193451 disclose virtual switches for virtualizing an actual (physical) disk at a network layer (switch layer) and providing users with a virtual disk independent of a host apparatus and a type of the actual disk.

FIG. 13 illustrates a known storage system 80. As illustrated in FIG. 13, a virtual switch 81 in the storage system 80 is arranged between a plurality of host apparatuses 82-1 through 82-3 (three host apparatuses in FIG. 13) and a plurality of actual disks 83-1 and 83-2 (two physical disks in FIG. 13).

The virtual switch 81 connects to the plurality of host apparatuses 82-1 through 82-3 and the plurality of physical disks 83-1 and 83-2 via a communication line of fibre channel (FC). The virtual switch 81 also connects to a management terminal 84 via a communication line (data transfer system) such as local area network (LAN).

The virtual switch 81 performs major functions by assigning a logical volume of any capacity sliced from each of the physical disks 83-1 and 83-2 to each of the host apparatuses 82-1 through 82-3. One major function (referred to as virtual disk function) is to provide users with at least one of the virtual disks (four virtual disks 85-0 through 85-3 in FIG. 13), independent of the host apparatuses 82-1 through 82-3 and the type of physical disks 83-1 and 83-2. Another major function (referred to as copy function) is to execute a copy process by splitting the copy process into a plurality of unit copy operations, each unit copy operation including a predetermined size, and performing the unit copy operations using a resource within the virtual switch 81 only, without using resources in the host apparatuses 82-1 through 82-3 (such as central processing units (CPUs) and memories).

The copy process includes backing up or moving data of a physical disk (for example, the physical disk 83-1 in FIG. 13) as a copy source onto a physical disk as a copy destination (for example, the physical disk 83-2 in FIG. 13) in accordance with content input to the management terminal 84.

The copy process based on the copy function is executed by a redundant arrays of inexpensive disks (RAID) device forming the physical disks 83-1 and 83-2 when the data of the physical disks 83-1 and 83-2 is periodically backed up or when data is moved from one of the physical disks 83-1 and 83-2 to a new disk when the one of the physical disks 83-1 and 83-2 is replaced with the new disk.

### SUMMARY

According to an aspect of the embodiment, a method for controlling a switch apparatus connectable to a host and a storage device including first and second areas, the method includes: establishing schedule of copying at least a part of data stored in the first area of the storage device into the second area of the storage device; monitoring a state of access by the host to the storage device; carrying out copying the at least a part of the data stored in the first area into the second area while the monitored state of the access by the host allows copying of the data from the first area into the second area; enhancing copying, if any portion of the at least a part of the data remains when a time set by the schedule is expired, the remaining portion of the at least a part of the data from the first area into the second area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 diagrammatically illustrates a virtual storage system in accordance with one embodiment of the present invention;

FIG. 2 illustrates one example of a copy process in the virtual storage system in accordance with one embodiment of the present invention;

FIG. 3 illustrates one example of the copy process in the virtual storage system in accordance with one embodiment of the present invention;

FIG. 4 illustrates one example of a process performed when a host apparatus accesses a virtual switch in the virtual storage system in accordance with one embodiment of the present invention;

FIG. 5 illustrates content of schedule information produced by a schedule information generator in the virtual storage system in accordance with one embodiment of the present invention;

FIGS. 6A and 6B illustrate a priority level determined by a priority determiner in the virtual storage system in accordance with one embodiment of the present invention;

FIG. 7 illustrates an example of a re-schedule process performed by a re-schedule processor in the virtual storage system in accordance with one embodiment of the present invention;

FIG. 8 illustrates another example of the re-schedule process performed by the re-schedule processor in the virtual storage system in accordance with one embodiment of the present invention;

FIG. 9 illustrates another example of the re-schedule process performed by the re-schedule processor in the virtual storage system in accordance with one embodiment of the present invention;

FIG. 10 illustrates a specific example of the re-schedule process performed by the re-schedule processor in the virtual storage system in accordance with one embodiment of the present invention;

FIG. 11 illustrates a copy process in the virtual storage system in accordance with one embodiment of the present invention;

FIG. 12 illustrates a structure of a known virtual storage system; and

FIG. 13 illustrates a known virtual storage system.

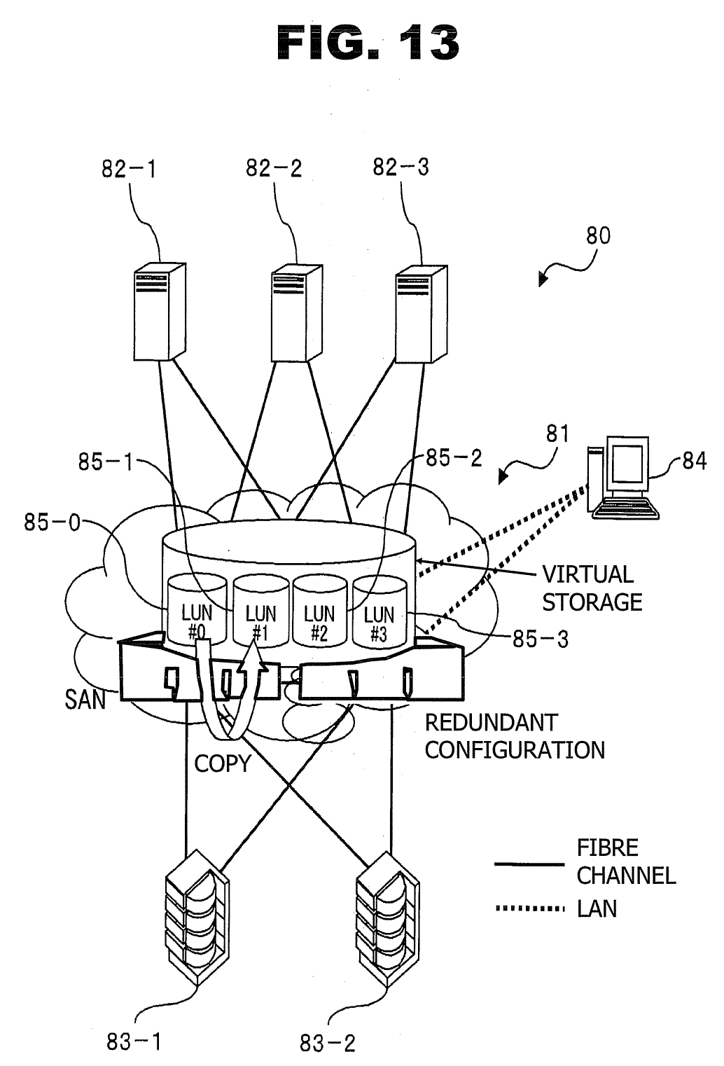

### DESCRIPTION OF EMBODIMENTS

As described previously, any other operation may not be interrupted by the copy process when it is executed. To this end, the copy process may not lower host I/O response of each of the host apparatuses 82-1 through 82-3.

For example, a user schedules the copy process in accordance with intervals manually selected from a plurality of levels (for high-speed copying, medium-speed copying, and low-speed copying). The unit copy operations are performed at the specified intervals at the scheduled timings.

More specifically, if the user sets the copy process priority to a lower level by specifying long intervals (for the low-speed copying, for example), the host I/O response has a higher priority. A speed reduction in the host I/O response responsive to the operation of the copy process is thus reduced.

The copy operations are performed at the scheduled timing. The host I/O response has a higher priority when it is not the scheduled timing of the unit copy operation. At the scheduled timing of the unit copy operation, however, the unit copy operation has a higher priority, and the host I/O response is kept waiting.

The host I/O response is thus lowered at the timing of the each unit copy operation.

There is a need for completing a copy process as scheduled by the user. The above-described technique simply allows the user to raise or lower a priority level of the copy process by selecting one from a plurality of preset intervals and does not allow the user to directly specify the end time of the copy process.

The end time of the copy process remains unknown. If the copy process is scheduled at long intervals with the host I/O response set at a higher priority (i.e., the copy process set at a lower priority), there is a possibility that the copy process is not completed before the time specified by the user.

Conversely, if the copy process is scheduled at short intervals with the end time of the copy process unknown (with the copy process set at a higher priority level), the priority level of the host I/O response may remain lowered even if the copy process is completed before the time specified by the user. It is thus difficult to efficiently perform the copy process.

If the copy process is performed using the RAID device, the copy process is performed only between storages of the same type.

The embodiment can reduce a speed reduction in a host I/O response due to the operation of a copy process and to complete the copy process on time as scheduled by a user.

The embodiments of the present invention are described below with reference to the drawings.

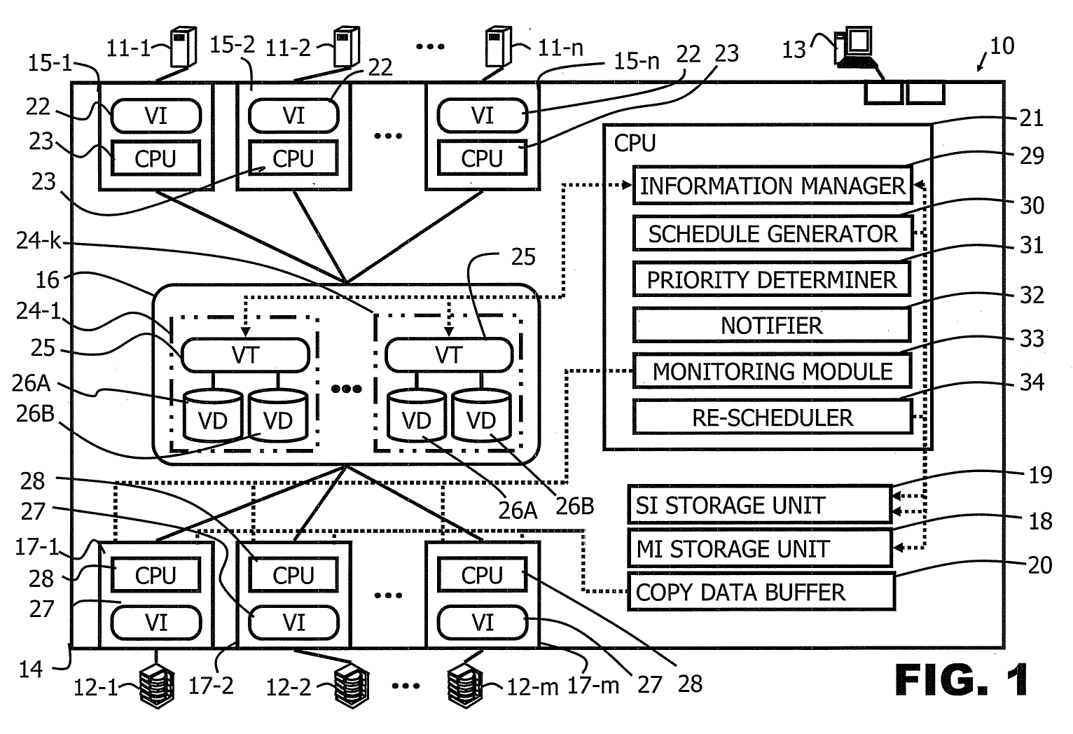

FIG. 1 diagrammatically illustrates a structure of a virtual storage system 10 in accordance with one embodiment of the present invention.

Referring to FIG. 1, the virtual storage system 10 of one embodiment of the present invention includes at least one host apparatus (high level apparatus) 11-1 through 11-n (n being a natural number), a plurality of physical disks (first and second storage areas) 12-1 through 12-m (redundant arrays of inexpensive disk (RAID) devices (m being a natural number), a management terminal 13, and a virtual switch (information processing apparatus) 14.

In the virtual storage system 10, the virtual switch 14 is arranged between the plurality of host apparatuses 11-1 through 11-n and the plurality of physical disks (storage devices) 12-1 through 12-m.

The virtual switch 14 is connected to each of the plurality of host apparatuses 11-1 through 11-n and the plurality of physical disks 12-1 through 12-m via a communication line such as fibre channel (data transfer system). The virtual switch 14 is also connected to the management terminal 13 via a communication line such as a local area network (LAN).

In the virtual storage system 10 of the present embodiment of the present invention, the virtual switch 14 virtualizes and generally manages the physical disks 12-1 through 12-m. The virtual switch 14 then assigns a virtual volume to each of the host apparatuses 11-1 through 11-n. For example, with each of the host apparatuses 11-1 through 11-n accessing an assigned virtual volume (storage units 24-1 through 24-k to be discussed later), the virtual switch 14 performs a host I/O response (post I/O process) to the physical disk 12. The physical disks 12-1 through 12-m are transparent to the host apparatuses 11-1 through 11-n.

The host I/O response refers to a data transfer process performed between each of the host apparatuses 11-1 through 11-n and each of the physical disks 12-1 through 12-m, and includes a host-side read process and a host-side write process. The host-side read process is a process of one of the host apparatuses 11-1 through 11-n for reading data from one of the physical disks 12-1 through 12-m. In the host-side read process, data is transferred from one of the physical disks 12-1 through 12-m to one of the host apparatuses 11-1 through 11-n via the virtual switch 14. The host-side write process is a process of one of the host apparatuses 11-1 through 11-n for writing data on one of the physical disks 12-1 through 12-m. Data is transferred from one of the host apparatuses 11-1 through 11-n to one of the physical disks 12-1 through 12-m via the virtual switch 14.

In the discussion that follows, reference numerals 11-1 through 11-n are used to individually identify the plurality of host apparatuses, and reference numeral 11 is used to refer to one host apparatus that represents all the host apparatuses.

The reference numerals 12-1 through 12-m are used to individually identify the plurality of physical disks, and reference numeral 12 is used to refer to one physical disk that represents all the physical disk.

In the discussion that follows, the host I/O response refers to both the host-side read process and the host-side write process.

The management terminal 13 manages a variety of information in the virtual storage system 10 by accessing the virtual switch 14 to be detailed later. The management terminal 13 includes, for example, a display (not illustrated) functioning as a graphic user interface (GUI), and an input unit for inputting information needed to execute the copy process to be discussed later, and a copy instruction (also referred to as a copy start instruction) for starting the copy process.

The information used to execute the copy process refers to copy source specifying information, copy destination specifying information, and specified time for the copy process (hereinafter referred to as copy operation time). The copy source specifying information is an address of the physical disk 12 as a copy source, and the copy destination specifying information is an address of the physical disk 12 of a copy destination. The copy operation time is time available for copying until the end of copying.

Observing a GUI screen, the user may input to the input unit of the management terminal 13 the copy source specifying information, the copy destination specifying information, and the copy operation time as information needed for the copy process. The management terminal 13 then transmits these pieces of input information to a schedule information generator 30 to be discussed later.

When the user inputs the copy start instruction to the input unit of the management terminal 13 later on, the management terminal 13 transmits the copy start instruction to the schedule information generator 30, a second processor (hereinafter referred to as a copy source second processor) 17 corresponding to the copy source specifying information and a second processor (hereinafter referred to as a copy destination second processor) 17 corresponding to the copy destination specifying information.

The virtual switch 14 virtualizes the physical disk 12 at a network layer (switch layer), and supplies the user with a virtual disk 26 (VD) that is independent of the host apparatus 11 and the physical disk 12. Referring to FIG. 1, the virtual switch 14 constructed as a computer includes at least one first processor (first port) 15-1 through 15-n, a virtual storage 16, a plurality of second processor (copy process executing unit or second port) 17-1 through 17-m, a mapping information storage unit 18 (MI storage unit), a schedule information storage unit 19 (SI storage unit), a copy data buffer 20, and a central processing unit (CPU) 21.

The virtual storage 16 includes at least one storage unit, 24-1 through 24-k (k being a natural number).

The first processors 15-1 through 15-n are respectively connected to the host apparatuses 11-1 through 11-n on a one-to-one correspondence basis, and connected to the virtual storage 16 in a manner such that accessing to each of the storage units 24-1 through 24-k is possible.

As illustrated in FIG. 1, the first processor 15-1 is connected to the host apparatus 11-1, the first processor 15-2 is connected to the host apparatus 11-2, . . . , and the first processor 15-n is connected to the host apparatus 11-n.

The second processors 17-1 through 17-m are connected to the virtual storage 16 in a manner such that accessing to each of the storage units 24-1 through 24-k is possible. The second processors 17-1 through 17-m are respectively connected to the physical disks 12-1 through 12-m on a one-to-one correspondence basis.

As illustrated in FIG. 1, the second processor 17-1 is connected to the physical disk 12-1, the second processor 17-2 is connected to the physical disk 12-2, . . . , and the second processor 17-m is connected to the physical disk 12-m.

In the discussion that follows, the reference numerals 15-1 through 15-n are used to individually identify the plurality of first processors, and reference numeral 15 is used to refer to one first processor that represents all the first processors.

The reference numerals 17-1 through 17-m are used to individually identify the plurality of second processors, and reference numeral 17 is used to refer to one second processor that represents all the second processors.

The reference numbers 24-1 through 24-k are used to individually identify the plurality of storage units, and reference numeral 24 is used to refer to one storage unit that represents all the storage units.

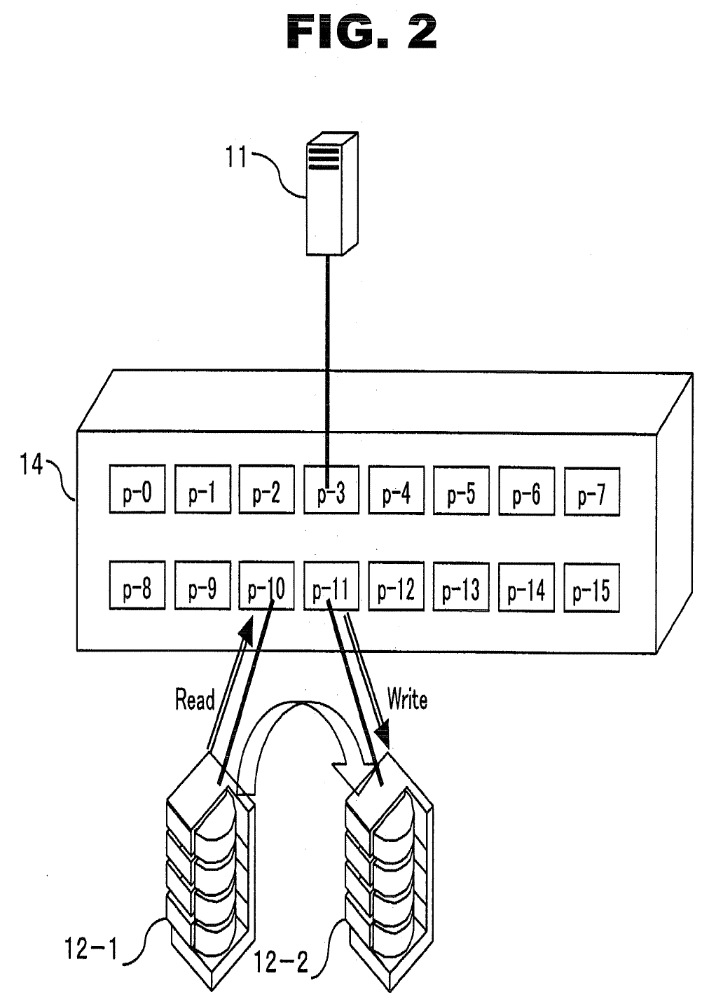

One first processor 15 is fixed to one port (represented by reference characters “p-0” through “p-7” in FIG. 2), and a virtual initiator (VI) 22 and a CPU 23 in the first processor 15 allows a data transfer process to be performed between the corresponding host apparatus 11 and virtual storage 16 (for example, virtual target (VT) 25 to be discussed later).

The storage unit 24 includes the virtual target (VT) 25 produced by the virtual switch 14 and a plurality of virtual disks (two virtual disks 26A and 26B in FIG. 1).

The VT 25 is designed to be accessed by the host apparatus 11 via the first processor 15. The VT 25 functions as a target when the host apparatus 11 accesses the virtual disk 26.

In the discussion that follows, the reference numerals 26A and 26B are used to identify the plurality of virtual disks, and reference number 26 is used to refer to one virtual disk that represents all the virtual disks.

The number of VTs 25, the number and size of virtual disks 26, a RAID type, a physical disk to be assigned, and concatenation of the physical disks may be set to any values by the user.

One second processor 17 is fixed to one respective port (represented by reference characters “p-8” through “p-15” in FIG. 2). VI 27 and CPU 28 in the second processor 17 allows a data transfer process to be performed between the corresponding physical disk 12 and the virtual switch 14. For example, in response to a request from a virtual configuration information manager 29 to be discussed later, the VI 27 issues a request for the host-side read process and a request for the host-side write process to the physical disk 12.

The virtual switch 14 assigns a logical volume of any capacity spliced from the physical disk 12 to the host apparatus 11. The virtual switch 14 has a function of providing a user with the virtual disk 26 independent of the host apparatus 11 and the type of the physical disk 12. This function is also referred to as a virtual disk function.

In addition to the virtual disk function, the virtual switch 14 also has a function of executing a copy process by splitting the copy process into a plurality of unit copy operations using resources only within the virtual switch 14 rather than using resources of the host apparatus 11 (such as CPU and memory). This function is also referred to as a copy function.

The copy process refers to a process in which data on the physical disk (hereinafter referred to as a copy source physical disk) 12 (first storage area such as the physical disk 12-1 of FIG. 1) corresponding to the copy source specifying information is backed up or moved to the physical disk (hereinafter referred to as a copy destination physical disk) 12 (second storage area such as the physical disk 12-2 of FIG. 1) corresponding to the copy destination specifying information. For example, at least a part of data stored in the first area of the storage device is copied into the second area of the storage device in the copy process (copying).

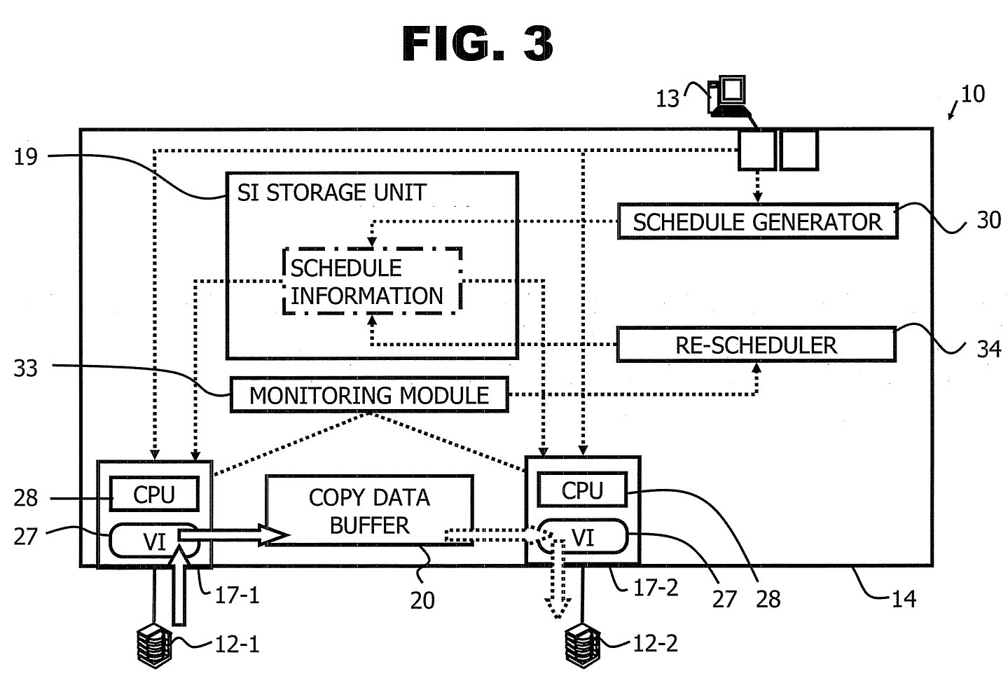

FIGS. 2 and 3 illustrate an example of a computer process in the virtual storage system in accordance with one embodiment of the present invention.

As illustrated in FIGS. 2 and 3, the copy process is performed from the copy source physical disk 12-1 to the copy destination physical disk 12-2. The second processor (hereinafter referred to as a copy source second processor) 17-1 corresponding to the copy source physical disk 12-1 performs a read process. More specifically, the copy source second processor 17-1 reads data on the copy source physical disk 12-1 via a port p-10 in a plurality of cycles in accordance with schedule information stored on the schedule information storage unit 19 and then stores temporarily the read data onto the copy data buffer 20. Then, the second processor (hereinafter referred to as a copy destination second processor) 17-2 corresponding to the copy destination physical disk 12-2 performs a write process. More specifically, the copy destination second processor 17-2 reads data stored on the copy data buffer 20 in a plurality of cycles in accordance with the schedule information stored on the schedule information storage unit 19 and writes the read data onto the copy destination physical disk 12-2 via the port p-11.

In the copy process performed from the copy source physical disk 12-1 to the copy destination physical disk 12-2, the copy source second processor 17-1 performs the read process and the copy destination second processor 17-2 performs the write process. The two second processors 17-1 and 17-2 function as the copy process executing unit.

In other words, the virtual switch 14 performs data transfer as the copy process between the virtual switch 14 and the physical disk 12 using no resource in the host apparatus 11 at all.

In the discussion that follows, a process related to the host I/O response is referred to as a host-side write process or a host-side read process, and a process related to the copy process is referred to as a write process or a read process.

For convenience of explanation, the copy process refers to both the read process and the write process.

The mapping information storage unit 18 stores mapping information that maps the virtual disk 26 to the physical disk 12 as illustrated in FIG. 1. The mapping information stored on the mapping information storage unit 18 is used when the virtual configuration information manager 29 determines the physical disk 12 to be actually accessed.

The schedule information storage unit 19 stores schedule information generated by the schedule information generator 30. The schedule information stored on the schedule information storage unit 19 is used when the copy source second processor 17 performs the copy process. The schedule information and the copy process performed by the second processor 17 in accordance with the schedule information will be described later.

The copy data buffer 20 buffers data read by the second processor 17 as the copy source when the copy process is performed from the physical disk 12 as a copy source to the physical disk 12 as a copy destination. The copy data buffer 20 may include a memory.

The CPU 21 in the virtual switch 14 performs a variety of numerical calculations, information processing, device control, etc. The CPU 21 functions as the virtual configuration information manager 29, the schedule information generator 30, a priority determiner 31, a notifier 32, a data transfer process monitoring module (data transfer amount monitoring module) 33, and a re-scheduler 34.

In response to the VT 25 accessed by the host apparatus 11, the virtual configuration information manager 29 determines the physical disk 12 to be actually accessed. For example, when the host apparatus 11 accesses any VT 25, the virtual configuration information manager 29 determines the physical disk 12 corresponding to the VT 25 accessed by the host apparatus 11 in accordance with the mapping information stored on the mapping information storage unit 18.

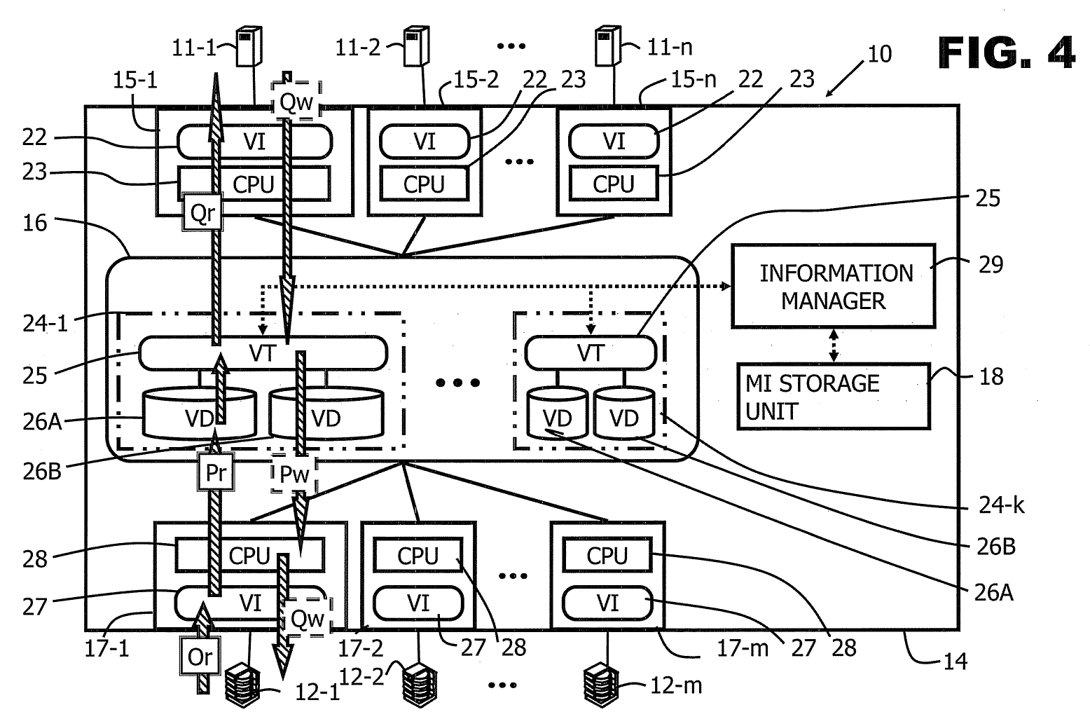

FIG. 4 illustrates a process example performed when the host apparatus accesses the virtual switch 14 in the virtual storage system 10 of one embodiment of the present invention.

More specifically, the host apparatus 11-1 accesses the VT 25 in the storage unit 24-1 via the first processor 15-1 as illustrated in FIG. 4. When the host-side write process is performed on the virtual disks 26A and 26B in the storage unit 24-1, the virtual configuration information manager 29 references the mapping information stored on the mapping information storage unit 18 in response to the write instruction (command and address) from the host apparatus 11-1, and determines a physical disk 12-1 corresponding to the VT 25 in the storage unit 24-1 and a destination address on the physical disk 12-1.

The VT 25 in the storage unit 24-1 issues a request for a host-side write process to the VI 27 in the second processor 17-1 corresponding to the physical disk 12-1 determined by the virtual configuration information manager 29. The VT 25 in the storage unit 24-1 then reads data (see reference characters “Ow” in FIG. 4) written from the host apparatus 11-1 on the virtual disks 26A and 26B in the storage unit 24-1 and then transfers the read data to the VI 27 in the second processor 17-1 (see reference characters “Pw” in FIG. 4). The second processor 17-1 writes the data on the second processor 17-1 onto the physical disk 12-1 (see reference characters “Qw” in FIG. 4).

As illustrated in FIG. 4, the host apparatus 11-1 may perform the host-side read process on the virtual disks 26A and 26B in the storage unit 24-1 by accessing the VT 25 in the storage unit 24-1 via the first processor 15-1. The virtual configuration information manager 29 references the mapping information stored on the mapping information storage unit 18 in response to the read instruction (command and address) from the host apparatus 11-1 and determines a physical disk 12-1 corresponding to the VT 25 in the storage unit 24-1 and a read destination address of the physical disk 12-1.

The VT 25 in the storage unit 24-1 issues a request for the host-side read process to the VI 27 in the second processor 17-1 corresponding to the physical disk 12-1 determined by the virtual configuration information manager 29. When the request for the host-side read process is issued to the VI 27, the second processor 17-1 reads data from the requested physical disk 12-1 (see reference characters “Or” in FIG. 4) and transfers the read data to the VT 25 in the storage unit 24-1 (see reference characters “Pr” in FIG. 4). The storage unit 24-1 writes the data on the VT 25 onto the virtual disks 26A and 26B in the storage unit 24-1.

When the data is written onto the virtual disks 26A and 26B in the storage unit 24-1, the VI 22 in the first processor 15-1 read the data from the virtual disks 26A and 26B in the storage unit 24-1 and transfers the read data to the host apparatus 11-1 (see reference characters “Qr” in FIG. 4).

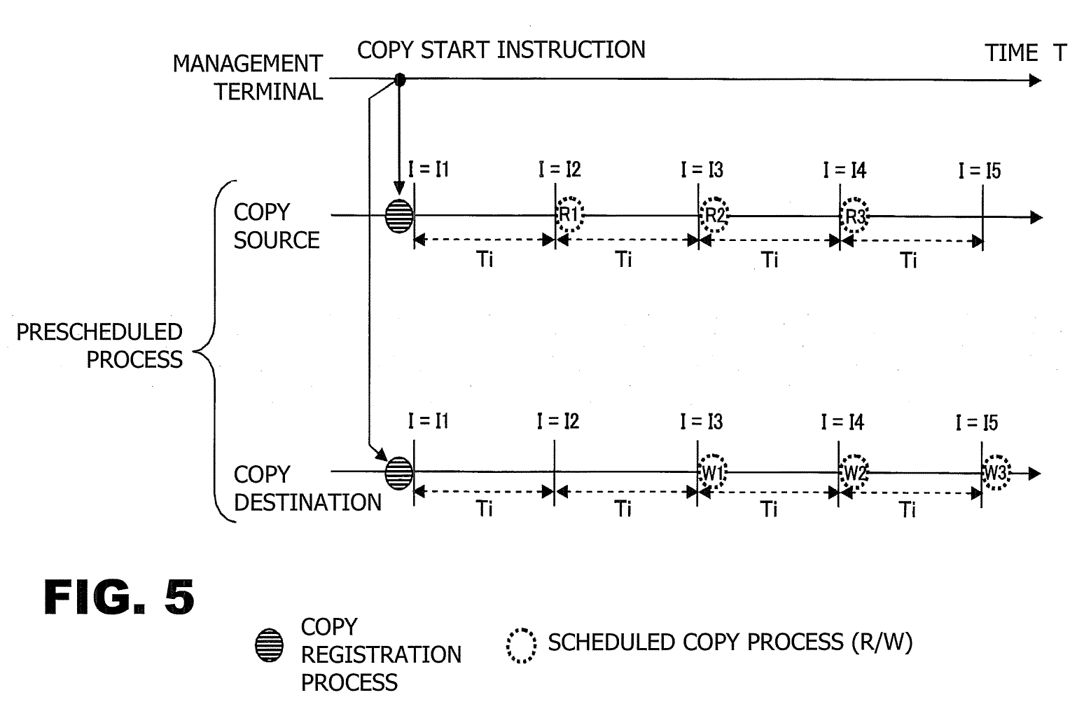

FIG. 5 illustrates content of the schedule information generated by the schedule information generator 30 in the virtual storage system 10 in accordance with one embodiment of the present invention.

Referring to FIG. 1, the schedule information generator 30 generates (establishes) beforehand the schedule information so that the copy process is split uniformly among a plurality of unit copy operations and is executed (this process is also referred to as prescheduling). When information needed for executing the above-described copy process is input to the input unit in the management terminal 13, the schedule information generator 30 calculates intervals Ti in accordance with the following equation (1) based on the copy operation time X specified by the user, a size of data in the physical disk 12 as a copy source (overall copy amount Y), and a size of unit data for a single unit copy operation (copy amount for one cycle Z fixed to each apparatus):

Ti=XZ/Y (1)

If the copy process is performed with the copy operation time X being 300 (minutes), the overall copy amount Y being 40960 (Mbytes), and the copy amount Z for a single unit copy operation being 16 (Mbytes), the interval Ti of 7.07 (seconds) results.

The schedule information generator 30 thus functions as an interval calculator (not illustrated) calculating the interval Ti on the basis of the copy operation time X, the overall copy amount Z, and the copy amount Z for one unit copy operation.

When the copy start instruction is input to the input unit in the management terminal 13, the schedule information generator 30 generates the schedule information for the copy source second processor 17 to execute the copy process. The copy source second processor 17 thus performs the unit copy operations at the intervals Ti, thereby copying data of a constant data size (unit data size) at each unit copy operation. The generation of the above-described schedule information and the storage of the schedule information are also collectively referred to as a copy registration process.

More specifically, as illustrated in FIGS. 2 and 3, the copy process may be performed from the copy source physical disk 12-1 to the copy destination physical disk 12-2. As illustrated in FIG. 5, when the copy start instruction is input to the input unit in the management terminal 13, the schedule information generator 30 generates the schedule information for the second processor 17-1 as the copy source to perform the read process. The schedule information is used for the second processor 17-1 as the copy source to execute each unit copy operation (also referred to as a unit read process) R1-R3 at constant intervals Ti. The schedule information generator 30 also generates the schedule information for the copy destination second processor 17-2 to perform the write process. The schedule information is used for the second processor 17-2 as the copy destination to execute each unit copy operation (also referred to as a unit write process) W1-W3 at constant intervals Ti. The copy registration process is thus performed.

In the copy registration process for the write process, the schedule information generator 30 generates the schedule information so that the unit write process is executed at a timing later than the timing prescheduled in response to the unit read process.

With reference to FIG. 5, the schedule information generator 30 generates the schedule information so that a first unit write operation W1 at the copy destination is performed at a timing I3 an interval Ti after a timing I2 prescheduled for a first read operation R1 at the copy source. Similarly, the schedule information generator 30 generates the schedule information so that second and third unit write operations W2 and W3 at the copy destination are performed at timings I4 and I5 respectively an interval Ti after timings I3 and I4 prescheduled for second and third unit read operations at the copy source.

In the discussion that follows, unit copy operation includes a unit read operation and a unit write operation for convenience of explanation.

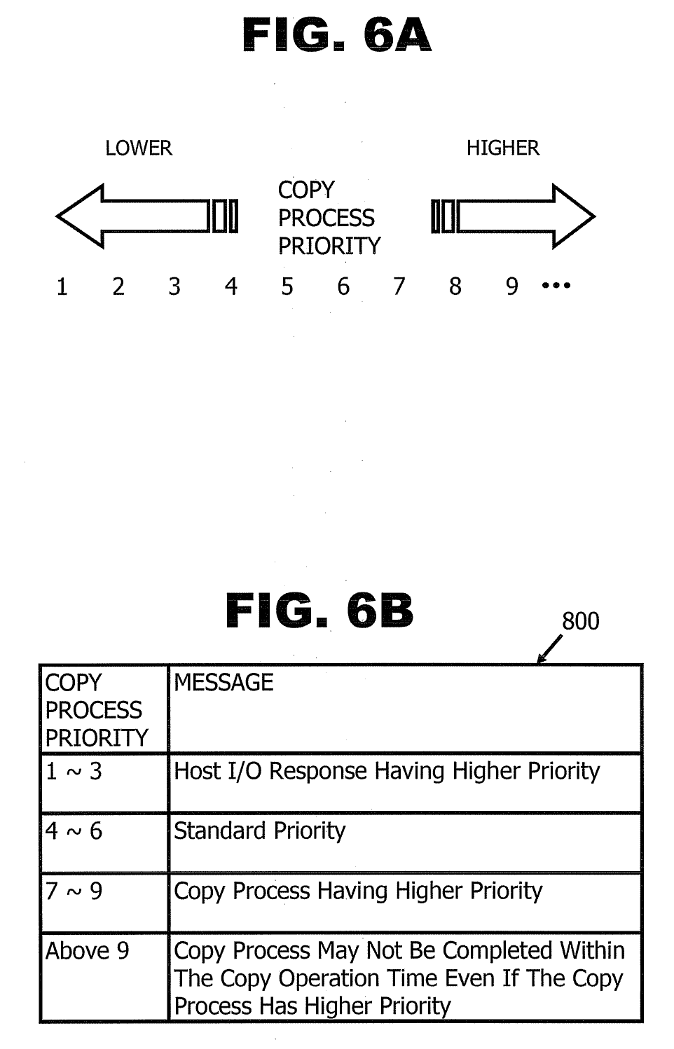

FIGS. 6A and 6B illustrate a priority level determined by the priority determiner 31 in the virtual storage system 10 in accordance with one embodiment of the present invention.

The priority determiner 31 automatically determines a priority level of the copy process with respect to the host I/O response in the middle of the copy process. For example, the priority determiner 31 automatically selects, from a plurality of indexes preset depending on the length of intervals, an index matching the interval Ti calculated by the schedule information generator 30. The priority determiner 31 thus determines the priority level.

The indexes indicating the priority levels may be a plurality of level values based on the relationship that the longer the intervals of unit copy operations, the lower the priority of the copy process (i.e., the host I/O response set at a higher priority level).

With reference to FIGS. 6A and 6B, the priority determiner 31 uses an integer of 1 or greater as an index of the copy priority. As illustrated in FIG. 6A, the copy process increases priority with the increasing number from 1 representing the lowest priority.

FIG. 6B is an example of list 800 of priority level. With reference to 6B, the priority determiner 31 provides a number of 1 to 3 as a priority index with the host I/O response including a higher priority, a number of 4 to 6 as a standard priority index, and a number of 7 to 9 with the copy process including a higher priority. The priority determiner 31 also provides a number 9 as a priority index at which the copy process may not be completed within the copy operation time even if the copy process has a higher priority.

The notifier 32 notifies of the schedule information generated by the schedule information generator 30. The notifier 32 transmits to the management terminal 13 the priority index determined by the priority determiner 31, and displays a message responsive to the priority level (see FIGS. 6A and 6B) on a display (GUI screen) of the priority determiner 31. The notifier 32 thus notifies the user of the priority level at which the copy process is to be performed under the condition input to the input unit in the management terminal 13.

If the priority determiner 31 determines a priority index above 9, the notifier 32 displays a message on the GUI screen requesting the user to re-input (re-specify) a copy operation time of the copy process.

The user recognizes the message (priority level) displayed on the GUI screen. Upon deciding to perform the copy process at this priority level, the user inputs an instruction to start the copy process to the input unit in the management terminal 13. In response to the input of the instruction to start the copy process, the management terminal 13 transmits the input instruction to the schedule information generator 30, the second processor 17 as the copy source and the second processor 17 as the copy destination. The copy registration process is thus performed.

If the user decides not to perform the copy process at this priority level, the user re-inputs a copy operation time of the copy process to the input unit in the management terminal 13.

The monitoring unit 33 monitors a state of access by the host to the storage device. For example, the data transfer process monitoring module 33 monitors a data transfer amount of the host I/O response (hereinafter simply referred to as data transfer amount) in the second processor 17 on a per port basis (see reference characters “p-8” through “p-15” in FIG. 2). The data transfer process monitoring module 33 detects the data transfer amount in each of the second processors 17-1 through 17-m on a per port basis.

The copy process may be performed from the copy source physical disk 12-1 to the copy destination physical disk 12-2 with reference to FIGS. 2 and 3. From the end of the copy registration process to the end of the copy process, the data transfer process monitoring module 33 detects the data transfer amount in each of the copy source second processor 17-1 and the copy destination second processor 17-2 with a predetermined period shorter than the interval Ti.

The re-scheduler 34 performs a re-schedule process, re-scheduling the schedule information stored on the schedule information storage unit 19 in accordance with the data transfer amount monitored by the data transfer process monitoring module 33. For example, the re-scheduler 34 acquires the data transfer amount of each of the copy source second processor 17 and the copy destination second processor 17, and then determines whether the acquired data transfer amount is less than a predetermined value.

If the data transfer process monitoring module 33 determines that the acquired data transfer amount is less than the predetermined value, the re-scheduler 34 performs the re-schedule process so that any of a plurality of unit copy operations is performed ahead of schedule. For example, if the data transfer process monitoring module 33 determines that the data transfer amount of one of the copy source second processor 17 and the copy destination second processor 17 is less than the predetermined value, the re-scheduler 34 performs the re-schedule process so that a unit copy operation to be performed next by the second processor 17 is performed at the present time ahead of schedule.

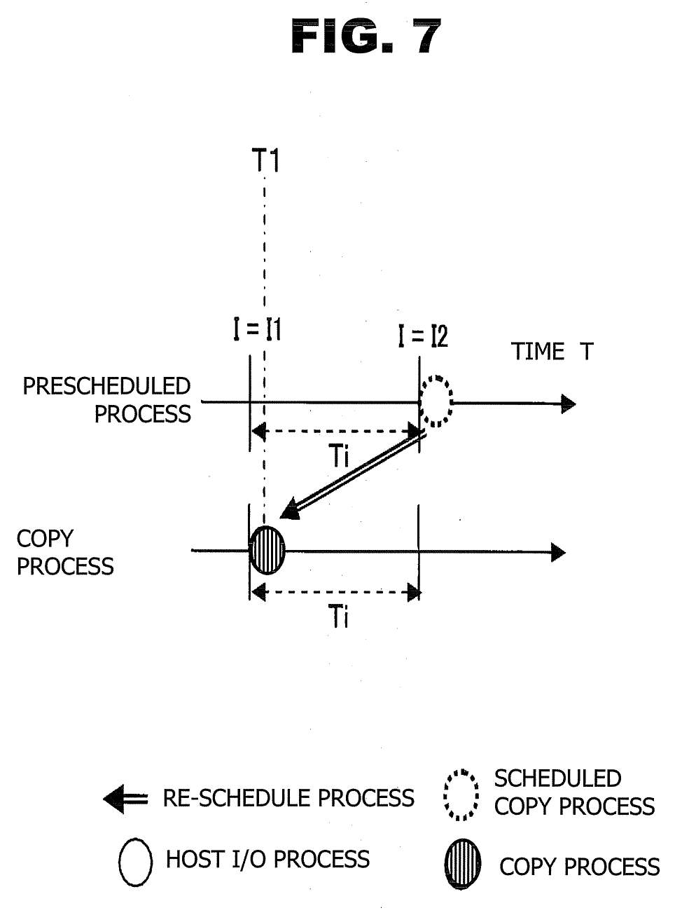

FIGS. 7-9 illustrate one example of the re-schedule process performed by the re-scheduler 34 in the virtual storage system 10 in accordance with one embodiment of the present invention.

Referring to FIG. 7, if the re-scheduler 34 determines at time T1 that the data transfer amount of the second processor 17 is less than the predetermined value, the re-scheduler 34 performs the re-schedule process so that the unit copy operation to be executed by the second processor 17 as a determination target at a timing I2 is performed at time T1 ahead of schedule.

The re-scheduler 34 performs carrying out copying the at least a part of the data stored in the first area into the second area progressively while the monitored state of the access by the host allows copying of the data from the first area into the second area;

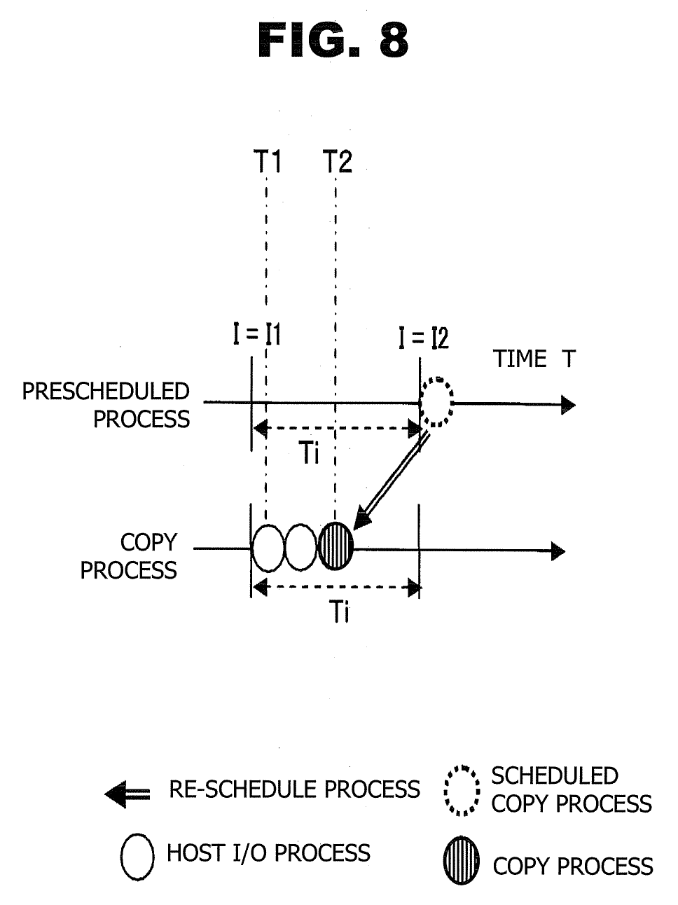

Referring to FIG. 8, if the re-scheduler 34 determines within a duration of time from time T1 to time T2 that the data transfer amount of the second processor 17 as the determination target is equal to or above the predetermined value, the re-scheduler 34 places at a higher priority the host I/O response of the second processor 17 as the determination target. If the re-scheduler 34 determines at time T2 that the data transfer amount of the second processor 17 is less than the predetermined value (with the host I/O response completed), the re-scheduler 34 performs the re-schedule process so that the unit copy operation to be performed at a next timing I2 by the second processor 17 as the determination target is to be performed at time T2 ahead of schedule.

In accordance with the present embodiment, the re-scheduler 34 allows the unit copy operation to be performed ahead of schedule by a duration of time not longer than the interval Ti. With reference to FIGS. 7 and 8, the re-scheduler 34 allows a next unit copy operation to be performed ahead of schedule not before the timing I1 preceding the timing I2 prescheduled.

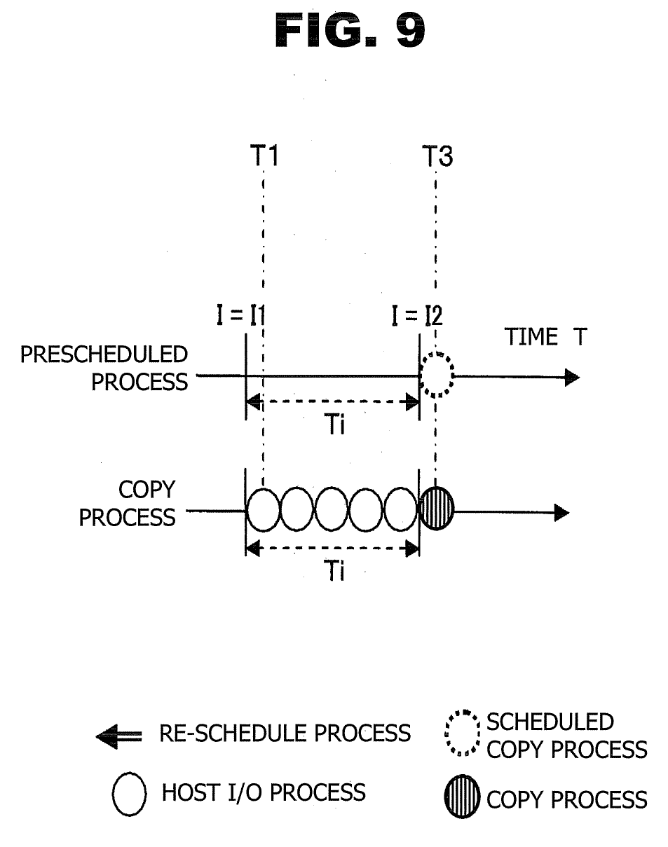

As illustrated in FIG. 9, a series of host I/O responses may remain to be processed from timing I1 at which a preceding unit copy operation is prescheduled (see time “T1” in FIG. 9) to timing I2 at which a next unit copy operation is prescheduled (see time “T3” in FIG. 9), and it may be repeatedly determined that the data transfer amount of the second processor 17 is equal to or above the predetermined value. In such a case, the re-scheduler 34 executes the next unit copy operation at time I2 as prescheduled without delaying.

The re-scheduler 34 performs enhancing copying, if any portion of the at least a part of the data remains when a time limit set by the schedule is expired, the remaining portion of the at least a part of the data from the first area into the second area.

Even if the data transfer amount monitored by the data transfer process monitoring module 33 is equal to or above the predetermined value, the re-scheduler 34 performs the re-schedule process so that each unit copy operation is completed before the timing of the schedule information prescheduled (generated prior to the re-schedule process).

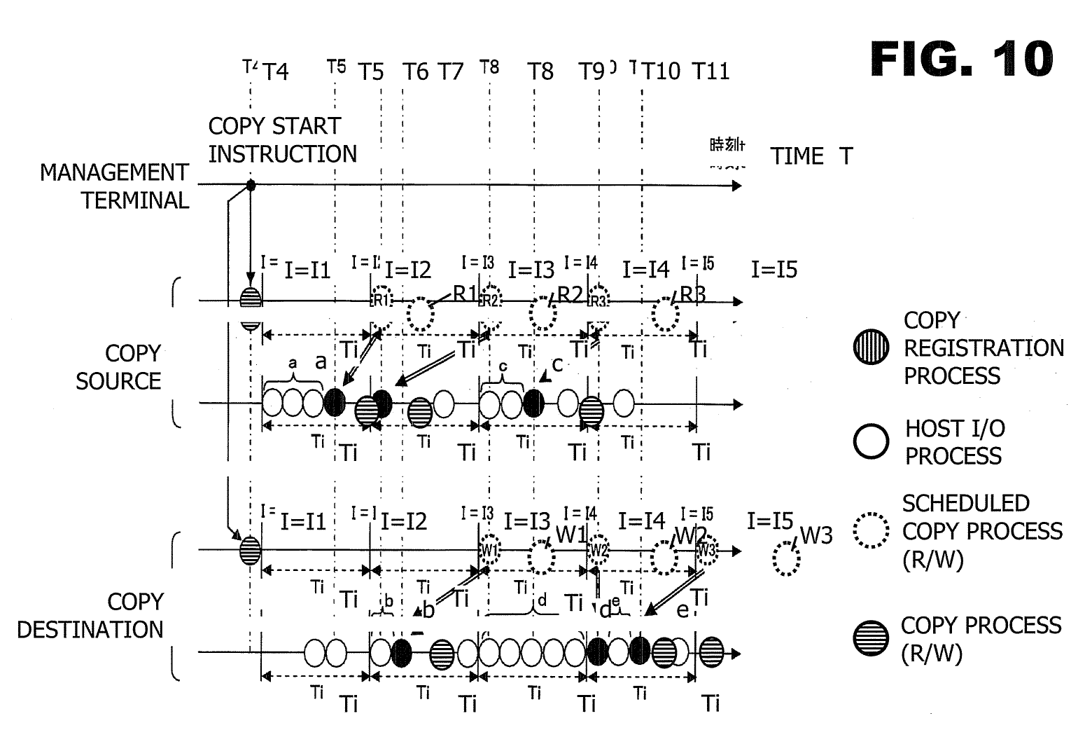

FIG. 10 illustrates a specific example of the re-schedule process performed by the re-scheduler 34 in the virtual storage system 10 in accordance with one embodiment of the present invention.

The re-schedule process of the re-scheduler 34 in the copy process performed from the copy source physical disk 12-1 to the copy destination physical disk 12-2 as illustrated in FIGS. 2 and 3 is described below with reference to FIG. 10.

Referring to FIG. 10, the schedule information generator 30 performs the copy registration process at time T4 (see time “T4” in FIG. 10). The re-scheduler 34 processes the host I/O response of the copy source second processor 17-1 with a higher priority as long as the re-scheduler 34 determines that the data transfer amount of the copy source second processor 17-1 is equal to or above the predetermined value (see reference character “a” and times “T4” and “T5” in FIG. 10).

If the re-scheduler 34 determines at time T5 that the data transfer amount of the copy source second processor 17-1 is less than the predetermined value, the re-scheduler 34 performs the re-schedule process so that a first unit read cycle R1 to be executed at a next timing I2 is performed at time T5 ahead of schedule.

At a time prior to time T6, namely, at a time prior to the prescheduled timing I3 by a period longer than the interval Ti, the re-scheduler 34 does not perform the re-schedule process. In other words, a first unit write operation W1 to be executed at next timing I3 is not performed prior to time T6 ahead of schedule even if the re-scheduler 34 determines that the data transfer amount of the copy destination second processor 17-2 is less than the predetermined value.

If the re-scheduler 34 determines at time T6 at the next prescheduled timing I2 that the data transfer amount of the copy source second processor 17-1 is less than the predetermined value, the re-scheduler 34 performs the re-schedule process so that a second unit read operation R2 to be executed at next timing I3 is performed at time T6 ahead of schedule.

At a time prior to time T8, namely, at a time prior to the prescheduled timing I4 by a period longer than the interval Ti, the re-scheduler 34 does not perform the re-schedule process. In other words, a third unit read operation R3 is not performed prior to time T8 ahead of schedule even if the re-scheduler 34 determines that the data transfer amount of the copy source second processor 17-1 is less than the predetermined value.

The re-scheduler 34 processes the host I/O response of the copy destination second processor 17-2 as long as the re-scheduler 34 determines at time T6 and thereafter that the data transfer amount of the copy destination second processor 17-2 is equal to or above the predetermined value (see reference character “b” in FIG. 10). If the re-scheduler 34 determines at time T7 that the data transfer amount of the copy destination second processor 17-2 is less the predetermined value, the re-scheduler 34 performs the re-schedule process so that a first write operation W1 to be executed at the next timing I3 is performed at time T7 ahead of schedule.

As long as the re-scheduler 34 determines at time T8 at the next prescheduled timing I3 and thereafter that the data transfer amount of the copy destination second processor 17-2 is equal to or above the predetermined value, the re-scheduler 34 processes the host I/O response of the copy source second processor 17-1 with a higher priority (see reference character “c” in FIG. 10). If the re-scheduler 34 determines at time T9 that the data transfer amount of the copy source second processor 17-1 is less than the predetermined value, the re-scheduler 34 performs the re-schedule process so that a third read operation R3 to be executed at next timing I4 is performed at time T9 ahead of schedule.

Since the re-scheduler 34 repeatedly determines time T8 through time T10 that the data transfer amount of the copy destination second processor 17-2 is equal to or above the predetermined value (see reference character “d” in FIG. 10), the re-scheduler 34 does not perform the re-schedule process that allows a second write operation W2 to be executed at the next timing I4 to be performed ahead of schedule. The copy destination second processor 17-2 executes the second unit write operation W2 as prescheduled (see time “T10” in FIG. 10).

As long as the re-scheduler 34 determines at time T10 and thereafter that the data transfer amount of the copy destination second processor 17-2 is equal to or above the predetermined value, the re-scheduler 34 processes the host I/O response of the copy destination second processor 17-2 (see reference character “e” in FIG. 10) with a priority. If the re-scheduler 34 determines at time T11 that the data transfer amount of the copy destination second processor 17-2 is less than the predetermined value, the re-scheduler 34 performs the re-schedule process so that a third unit write operation W3 to be executed at a next timing is executed at time T11 ahead of schedule.

In this way, the re-scheduler 34 performs the re-schedule process on the schedule information stored on the schedule information storage unit 19 in response to the data transfer amount monitored by the data transfer process monitoring module 33.

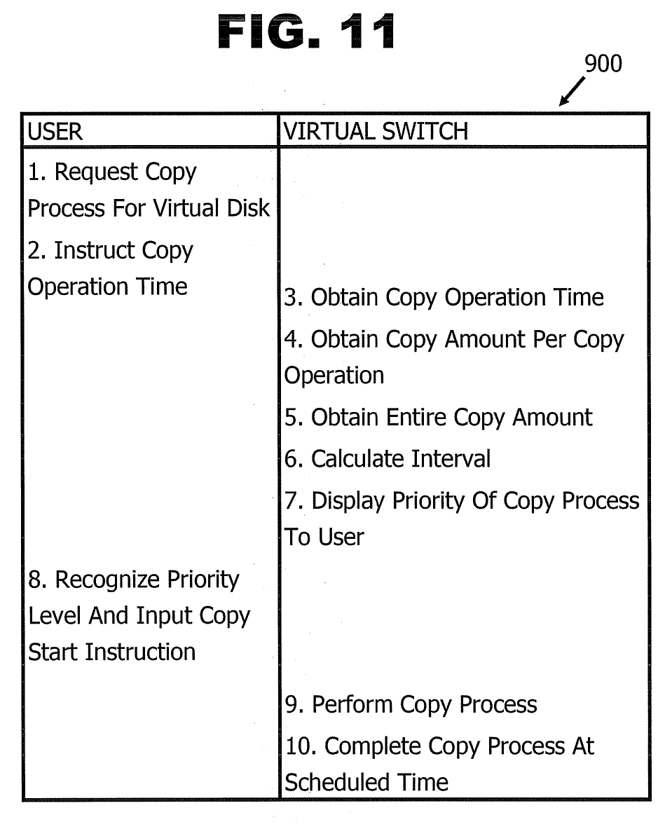

FIG. 11 illustrates one example of the copy process list 900 performed by the virtual storage system 10 in accordance with one embodiment of the present invention.

The copy process performed by the virtual storage system 10 in accordance with one embodiment of the present invention is described below with reference to FIG. 11 (numbers (1) through (10)).

The user inputs a copy request for a virtual disk while watching the GUI screen (refer to number (1)). The user then enters the copy source specifying information, the copy destination specifying information, and the copy operation time to the input unit in the management terminal 13 (an input step represented by number (2)).

The management terminal 13 transmits these pieces of input information to the virtual switch 14 (schedule information generator 30), and the virtual switch 14 acquires the transmitted information (refer to number (3)).

The schedule information generator 30 acquires a copy amount per copy operation (refer to number (4)), acquires the entire copy amount (refer to number (5)), and calculates the Ti based on the copy operation time T, the entire copy amount Y and the copy amount Z for one copy operation (refer to number (6)).

The priority determiner 31 automatically determines the priority level based on the interval Ti calculated by the schedule information generator 30. The notifier 32 displays a message responsive to the priority level determined by the priority determiner 31 on the display (GUI screen) of the management terminal 13. The user is thus notified of the priority level at which the copy process is to be performed in response to the input information on the input unit in the management terminal 13 (refer to a notification step represented by number (7)).

The user recognizes the priority level displayed on the GUI screen. Upon deciding to perform the copy process at that priority level, the user inputs the copy start instruction to the input unit in the management terminal 13 (refer to number (8)).

In response to the copy start instruction, the management terminal 13 transmits the input instruction to each of the schedule information generator 30, the copy source second processor 17 and the copy destination second processor 17.

The schedule information generator 30 performs the copy registration process (schedule information generation step). The copy source second processor 17 and the copy destination second processor 17 perform the copy process in accordance with the schedule information stored on the schedule information storage unit 19 (refer to number (9)). The re-scheduler 34 performs the re-schedule process on the schedule information stored on the schedule information storage unit 19. The re-scheduler 34 then completes the copy process at a scheduled time specified by the user (refer to number (10)). The copy process thus ends.

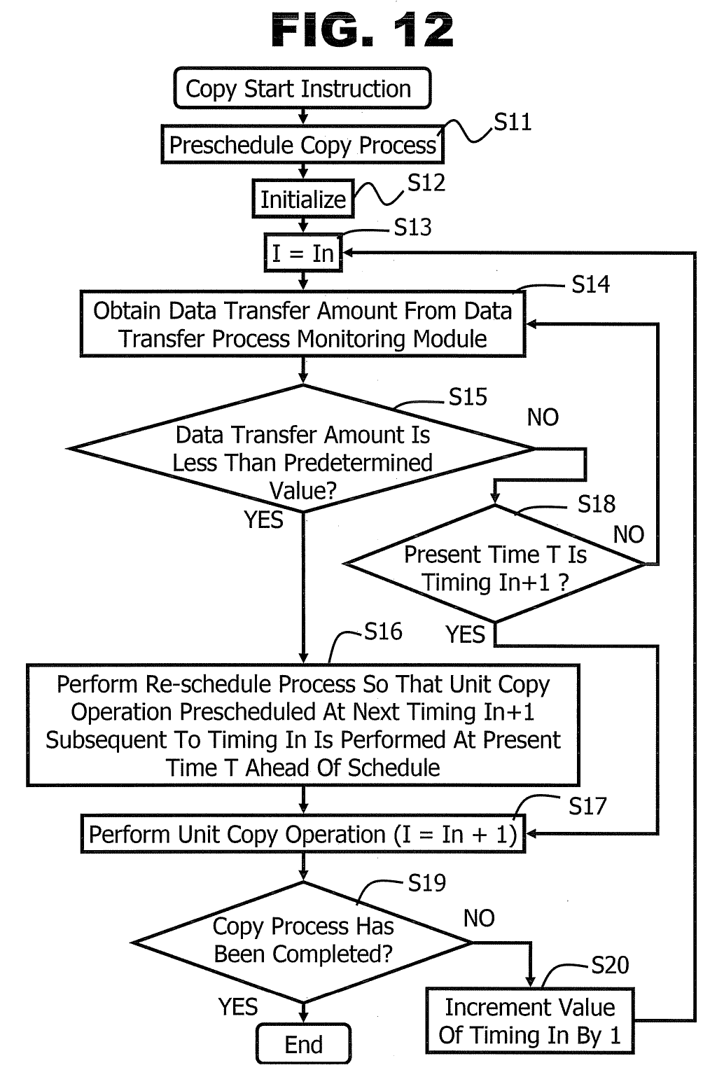

The re-schedule process of the re-scheduler 34 in the virtual storage system 10 thus constructed in accordance with one embodiment of the present invention is described below with reference to a flowchart (steps S11-S20) of FIG. 12.

Upon receiving the copy source specifying information, the copy destination specifying information, and the copy operation time information, the schedule information generator 30 performs the copy registration process (step S11). The re-scheduler 34 initializes the value of In (to In=I1) in step S12 where n is a variable.

At timing In (I=In) in step S13, the data transfer process monitoring module 33 monitors the data transfer amount of the second processor 17 (data transfer amount monitoring step). The re-scheduler 34 acquires the data transfer amount of the second processor 17-1 monitored by the data transfer process monitoring module 33 (step S14).

The re-scheduler 34 determines whether the data transfer amount of the second processor 17 is less than the predetermined value (step S15). If the re-scheduler 34 determines in step S15 that the data transfer amount of the second processor 17-1 is less than the predetermined value (“YES” in step S15), the re-scheduler 34 performs the re-schedule process so that a unit copy operation prescheduled at a next timing In+1 subsequent to the timing In is performed at the present time t ahead of schedule (step S16 as a re-schedule process step). The second processor 17 performs the unit copy operation, prescheduled at the next timing In+1, at present time t ahead of schedule in accordance with the schedule information stored on the schedule information storage unit 19 (step S17).

If the re-scheduler 34 determines in step S15 that the data transfer amount of the second processor 17 is equal to or above the predetermined value (“NO” in step S15), the re-scheduler 34 determines whether the present time t is the timing In+1 (step S18).

If the re-scheduler 34 determines in step S18 that the present time t is the timing In+1 (“YES” in step S18), processing proceeds to step S17. In accordance with the schedule information stored on the schedule information storage unit 19, the second processor 17 performs the unit copy operation at the next timing In+1 at the present time t as prescheduled. If the present time t is not yet the next timing In+1 (“NO” in step S18), processing proceeds to step 514.

When the second processor 17 performs the unit copy operation at the next timing In+1, the re-scheduler 34 determines whether all the copy process has been completed (step 519). If the re-scheduler 34 determines in step 519 that a part of the copy process has not yet been completed (“NO” in step 519), the re-scheduler 34 increments the value of the timing In by 1 (step S20), and returns to step 513.

If the re-scheduler 34 determines that all the copy process has been completed (“YES” in step 519), processing ends.

In accordance with the virtual storage system 10 of one embodiment of the present invention, the data transfer amount exchanged between the second processor 17 and the host apparatus 11 is monitored on a per port basis, and the schedule information is generated so that the copy process is prescheduled to be performed in a plurality of unit copy operations from the copy source physical disk 12-1 to the copy destination physical disk 12-2. The re-schedule process is performed on the schedule information in accordance with the data transfer amount between the second processor 17 and the host apparatus 11. The copy process is not always performed in accordance with the prescheduled timing, but performed in accordance with the rescheduled timing taking into consideration the host I/O response. The drop in the host I/O response due the effect of the copy process is thus reduced.

If the data transfer amount of the second processor 17 is less than the predetermined value, the re-schedule process is performed so that the second processor 17 as the determination target performs the unit copy operation to be performed next is performed at the present time ahead of schedule. Without waiting for the prescheduled timing, the second processor 17 performs the unit copy operation when the data transfer amount is small between the second processor 17 and the host apparatus 11. The drop in the host I/O response due the effect of the copy process at the prescheduled timing is thus reduced.

Even if the data transfer amount of the second processor 17 is equal to or above the predetermined value, each unit copy operation is performed in accordance with the prescheduled timing indicated by the schedule information without any delay. The copy process is completed at the time specified by the user.

The schedule information generator 30 generates the schedule information based on the copy operation time, the data size of the data on the physical disk 12 at the copy source, and the size of the unit data processed at a unit copy operation. In accordance with the schedule information, the second processor 17 performs the unit copy operations for uniform unit sizes at the predetermined intervals Ti. The load of the copy process is uniformly split.

The user is notified of the priority level determined by the priority determiner 31. The priority level is thus clearly presented to the user.

After the copy source second processor 17 copies the data on the copy source physical disk 12 to the copy data buffer 20, the copy destination second processor 17 writes the data stored on the copy data buffer 20 onto the copy destination physical disk 12. The copy process is performed using the functions of the virtual switch 14. The copy process is thus performed independent of the storage units and the types of the storage units.

The present invention is not limited to the above-described embodiments. A variety of modifications are possible without departing from the scope of the present invention.

For example, in accordance with the above-described embodiments, the virtual switch 14 includes the mapping information storage unit 18, the schedule information storage unit 19, and the CPU 21. The present invention is not limited to this arrangement. The mapping information storage unit 18, the schedule information storage unit 19, and the CPU 21 may be included in the management terminal 13 or in the RAID device forming the plurality of physical disks 12-1 through 12-m.

In accordance with the above-described embodiments, the copy process is performed from the copy source physical disk 12-1 to the copy destination physical disk 12-2. Alternatively, the copy process may be performed from the copy source physical disk 12-1 to the same copy source physical disk 12-1. In this case, as well, the data on the physical disk 12-1 as the copy source is temporarily stored on the copy data buffer 20, and then the data on the copy data buffer 20 is written onto the physical disk 12-1 as the copy destination.

In accordance with the above-described embodiments, the data transfer process monitoring module 33 generally monitors the data transfer amounts of the second processors 17-1 through 17-m. The present invention is not limited to this arrangement. The data transfer process monitoring module 33 may arranged for each port of the virtual switch 14 so that the data transfer amounts of the second processors 17-1 through 17-m are individually monitored.

The CPU 21 and the management terminal 13 execute the schedule management program, thereby functioning as the virtual configuration information manager 29, the schedule information generator 30, the priority determiner 31, the notifier 32, the data transfer process monitoring module 33, and the re-scheduler 34.

The schedule management program for performing the functions of the virtual configuration information manager 29, the schedule information generator 30, the priority determiner 31, the notifier 32, the data transfer process monitoring module 33, and the re-scheduler 34 may be provided in computer readable recording media. Such recording media include a flexible disk, compact disks (CD) such a compact disk ROM (CD-ROM), a compact disk recordable (CD-R), and a compact disk re-writable (CD-RW), digital versatile disks (DVDs) such as DVD-ROM, DVD-RAM, DVD-R, DVD+R, DVD-RW, and DVD+RW, a magnetic disk, an optical disk, and a magneto-optical disk. A computer reads the program from such a recording medium, and transfers the program onto one of an internal recording device and an external recording device for storage. The program may be recorded on a recording device (recording medium) such as a magnetic disk, an optical disk, or a magneto-optical disk, and then the program may be supplied to the computer via a communication line.

To perform the functions of the virtual configuration information manager 29, the schedule information generator 30, the priority determiner 31, the notifier 32, the data transfer process monitoring module 33, and the re-scheduler 34, the program stored on the internal recording device is executed by a microprocessor in the computer. In this case, the program recorded on the recording medium may read and executed by the computer.

In accordance with embodiments of the present invention, the computer includes hardware and an operating system and means the hardware operating under the control of the operating system. If the hardware is operated by an application program alone with the operating system unused, the hardware itself corresponds to the computer. The hardware includes, at least, a microprocessor such as a CPU, and means for reading a computer program recorded on the recording medium. In accordance with embodiments of the present invention, the virtual switch 14 and the management terminal 13 has the functions as the computer.

The recording media of embodiments of the present invention include a flexible disk, a CD, a DVD, a magnetic disk, an optical disk, a magneto-optical disk, an IC card, a ROM cartridge, a magnetic tape, a punch card, internal memories (such as RAM or ROM), an external storage device, and a variety of computer readable media such as printed matter including bar code printed thereon.

In accordance with embodiments of the present invention, the first processor 15 connected to the host apparatus 11 and the second processor 17 connected to the physical disk 12 have been discussed as separate units. Alternatively, the first processor 15 may have the function of the second processor 17.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alterations could be made hereto without departing from the spirit and scope of the invention.

What is claimed is:

1. A method for controlling a switch apparatus connectable to a host and a storage device including first and second areas for storing data, comprising:
establishing schedule of copying at least a part of data stored in the first area of the storage device into the second area of the storage device;
monitoring a state of access by the host to the storage device;
carrying out copying of the at least a part of the data stored in the first area into the second area while the monitored state of the access by the host allows copying of the data from the first area into the second area; and
enhancing copying, if any portion of the at least a part of the data remains when time set by the schedule is expired, of the remaining portion of the at least a part of the data from the first area into the second area.

2. The method according to claim 1, wherein the establishing further determines the schedule by dividing the at least a part of data into a plurality of sub-copying data, dividing a period information indicating period until completion of the copying into sub-period information on the basis of the number of the plurality of sub-copying data, and setting each of the sub-period information to the sub-copying data.

3. The method according to claim 2, wherein the dividing the at least a part of data divides the at least a part of data on the basis of amount of data of unit of copying process predetermined to the storage device.

4. The method according to claim 1, wherein the monitoring monitors the state of access on the basis of amount of transferring data between the host and each of the first area and the second area.

5. The method according to claim 1, wherein the switch apparatus further includes a data buffer for storing the at least a part of the data, the copying further stores the at least a part of the data into the data buffer.

6. The method according to claim 1, further comprising outputting error information when the completion of the copy process is over the period information even if the copy process.

7. An information processing apparatus connected to a host, a first storage area and a second storage area, the information processing apparatus comprising:
copy process executing means for executing a copy process on the basis of schedule information indicating timing the copy process for copying data on the first area onto the second area split into a plurality of unit copy operations;
data transfer amount monitoring means for monitoring a data transfer amount of data transferred between the copy process executing means and the host apparatus; and
re-scheduling means for performing a re-schedule process on the schedule information in response to the data transfer amount monitored by the data transfer amount monitoring means.

8. The information processing apparatus according to claim 7, wherein the re-scheduling means performs the re-schedule process so that one of the plurality of unit copy operations is performed ahead of schedule if the data transfer amount monitored by the data transfer amount monitoring means is less than a predetermined value.

9. The information processing apparatus according to one of claim 7, wherein the re-scheduling means performs the re-schedule process so that each unit copy operation is completed by a timing indicated by the schedule information generated prior to the re-schedule process even if the data transfer amount monitored by the data transfer amount monitoring means is equal to or above the predetermined value.

10. The information processing apparatus according to one of claim 7, further including a schedule information generator for generating the schedule information so that the unit copy operations are performed at predetermined intervals based on a specified operation time of the copy process, a size of data of the first storage area, and a size of unit data for the unit copy operation.

11. The information processing apparatus according to claim 7, further including a notifier for notifying of information related to the schedule information generated by the schedule information generator.

12. A switch apparatus connectable to a host and a storage device including first and second areas, the switch apparatus comprising:
a monitoring module for monitoring a state of access by the host to the storage device; and
a copy processor for copying at least a part of data stored in the first area of the storage device into the second area of the storage device by establishing schedule, the copy processor carrying out copying the at least a part of the data stored in the first area into the second area while the monitored state of the access by the host allows copying of the data from the first area into the second area, and the copy processor enhancing copying, if any portion of the at least a part of the data remains when a time set by the schedule is expired, the remaining portion of the at least a part of the data from the first area into the second area.

13. The switch apparatus according to claim 12, wherein the copy processor further determines the schedule by dividing the at least a part of data into a plurality of sub-copying data, dividing a period information indicating period until completion of the copying into sub-period information on the basis of the number of the plurality of sub-copying data, and setting each of the sub-period information to the sub-copying data.

14. The switch apparatus according to claim 13, wherein the copy processor further determines the schedule by dividing the at least a part of data on the basis of amount of data of unit of copying process predetermined to the storage device.

15. The switch apparatus according to claim 12, wherein the monitoring module monitors the state of access on the basis of amount of transferring data between the host and each of the first area and the second area.

16. The switch apparatus according to claim 12, wherein the switch apparatus further includes a data buffer for storing the at least a part of the data, the copying further stores the at least a part of the data into the data buffer.

17. The switch apparatus according to claim 12, further comprising outputting module for outputting error information when the completion of the copying is over the period information even if the copy process.
